(19) United States
(12) Patent Application Publication
(10) Pub. No.: US 2026/0203746 A1
(43) Pub. Date: Jul. 16, 2026

(54) SECURE NFC CARD ACTIVATION

(71) Applicant: Visa International Service Association, San Francisco, CA (US)

(72) Inventors: Yuexi CHEN, Foster City, CA (US); Chackan LAI, Hayward, CA (US)

(73) Assignee: Visa International Service Association, San Francisco, CA (US)

(21) Appl. No.: 19/131,351

(22) PCT Filed: Dec. 3, 2022
(86) PCT No.: PCT/US2022/080872

§ 371 Date: May 20, 2025

(51) Int. Cl. G06Q 20/34; H04W 4/80

(52) U.S. Cl. CPC G06Q 20/354; G06Q 20/341; H04W 4/80; G06Q 2220/00

(57) ABSTRACT

Systems and methods for securely activating a physical card capable of NFC are disclosed. These may comprise authenticating, by a mobile device capable of NFC communication, a user via an issuer application on the mobile device; determining, by the mobile device, based on user data available to the issuer application, that the user has been issued the physical card, wherein the physical card is inactive and NFC-enabled; prompting, the user, by the mobile device, to place the physical card within a communication distance to the mobile device; detecting, by the mobile device, the physical card within the communication distance to the mobile device; executing, by the mobile device, an NFC-based ODA transaction with the physical card; based on a success of the ODA transaction, authenticating, by the mobile device, a validity of the physical card with the issuer, to allow activation of the card.

### TECHNICAL FIELD

The present technology pertains to protecting account and card security, via systems and methods designed to prevent the activation of issued cards without authentication and validation. In particular but by no way of limitation, systems and methods of secure Near-Field Communication (“NFC”) validation of physical cards is described herein.

### SUMMARY

In various aspects, the present technology is directed to a computer implemented method for securely activating a physical card capable of near field communication (NFC), the card provided by an issuer to a user, wherein the method comprises authenticating, by a mobile device capable of NFC communication, the user via an issuer application on the mobile device; determining, by the mobile device, based on user data available to the issuer application, that the user has been issued the physical card, wherein the physical card is inactive and NFC-enabled; prompting, the user, by the mobile device, to place the physical card within a communication distance to the mobile device; detecting, by the mobile device, the physical card within the communication distance to the mobile device; executing, by the mobile device, an NFC-based offline data authentication (ODA) transaction with the physical card; based on a success of the NFC-based ODA transaction, authenticating, by the mobile device, a validity of the physical card with the issuer, to allow activation of the card; and activating, by the card issuer, the physical card.

In several aspects, the computer implemented method further comprises automatically launching the issuer application upon placement of the physical card within the communication distance to the mobile device.

In several aspects, the computer implemented method further comprises at least one of automatically triggering a download of the issuer application into the mobile device upon placement of the physical card within the communication distance to the mobile device, or automatically navigating to a download location of the issue application upon placement of the physical card within the communication distance to the mobile device.

In several aspects, the prompting is based on a location data available to the mobile device, the location data comprised of at least one of physical card location data, or user location data.

In several aspects, the detecting of the physical card within the communication distance comprises detecting the physical card being tapped to the mobile device.

In several aspects, the mobile device utilizes an NFC polling mechanism configured to automatically detect and attempt to connect to nearby NFC-enabled cards.

In several aspects, the computer implemented method further comprises establishing, a connection, via the NFC, between the mobile device and the physical card link.

In several aspects, the computer implemented method further comprises establishing, a connection, via the NFC, between the issuer application and the physical card, upon the issuer application determining that the physical card is within the communication distance from the mobile device.

In several aspects, the authenticating of the user is based on at least one of a PIN code, a password, or a user biometric.

In several aspects, the NFC based ODA transaction comprises sending by the issuer application, via the NFC, a first command to the physical card to obtain card information from the physical card; receiving by the issuer application, via the NFC, the card information from the physical card in response to the first command; sending by the issuer application, via the NFC, a second command to the physical card, based on the card information, to obtain security data; and receiving by the issuer application, via the NFC, a response that comprises at least one of the security data, or an application file locator.

In several aspects, the ODA transaction further comprises based on receiving the application file locator, sending by the issuer application, via the NFC, a third command to the physical card to obtain additional security data based on the application file locator; and receiving by the issuer application, via the NFC, the additional security data.

In several aspects, the NFC-based ODA transaction further comprises recovering, by the issuer application, security certificates from the security data; and validating, by the issuer application, the security certificates to successfully complete the NFC-based ODA transaction.

In several aspects, the security data comprises at least one of an encryption key, or a security certificate.

In various aspects, the present technology is directed to a client device comprising a display; a wireless interface capable of Near-Field Communication (NFC); a processor in communication with the wireless interface; and a memory in communication with the processor, the memory comprising an application associated with an issuer, wherein the application comprises instructions to be executed by the processor to present a prompt on the display of the client device to place a physical card within a communication distance to the client device; receive a confirmation from the wireless interface that the physical card is within the communication distance to the client device; establish a connection by the wireless interface between the application and the physical card within the communication distance; execute an NFC-based offline data authentication (ODA) transaction with the physical card; and based on a success of the NFC-based ODA transaction, authenticate, a validity of the physical card.

In several aspects, the processor of the client device is configured to receive data regarding detection of the physical card by the wireless interface; determine, based on information available to the client device, that the physical card is associated with the application; and launch the application automatically upon the determining that the physical card is associated with the issuer.

In several aspects, the application further comprises instructions to authenticate a user with the issuer to allow access to the application.

In several aspects, the application further comprises instructions to establish a connection between the application and a remote issuer system; and receive data from the remote issuer system indicating that the physical card has been issued to the user.

In several aspects, the application further comprises instructions to transmit a data object comprising a confirmation of the validity of the physical card to the remote issuer system; and initiate a card activation process with the remote issuer system to enable use of the physical card.

In various aspects, the present technology is directed to an issuer system to authenticate a physical card in communication with a remote client device, the issuer system comprising an issuer interface; and a server running an issuer service, the issuer service configured to: receive a connection request from the issuer interface to establish a secure communication channel between the issuer interface and the issuer service, wherein the connection request comprises credentials provided by the issuer interface; authenticate the issuer interface based on the credentials; establish an encrypted communication channel with the issuer interface; receive a confirmation, from the issuer interface, indicative of a successful verification of the physical card via an NFC-enabled validation process; and receive an activation request to activate the physical card, wherein the activation request comprises card details.

In several aspects, the issuer service is further configured to authenticate the physical card based on the card details and data available to the issuer service; activate the card on behalf of the issuer; and transmit a notification to the interface confirming a successful activation of the physical card.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a system architecture for securely validating a physical card for activation, according to at least one aspect of the present disclosure.

FIG. 2 illustrates a flow diagram for one aspect of a method to validate a physical card via NFC, according to at least one aspect of the present disclosure.

FIG. 3 illustrates a flow diagram for one aspect of a method to validate a physical card, according to at least one aspect of the present disclosure.

FIG. 4 illustrates a flow diagram for one aspect of a method to validate a physical card with an issuer service, according to at least one aspect of the present disclosure.

FIG. 5A-5B illustrates a diagrammatical representation of various components of a system architecture for validating a physical card for activation, according to at least one aspect of the present disclosure.

FIG. 6 presents a block diagram of a computer apparatus, according to at least aspect of the present disclosure.

FIG. 7 is a diagrammatic representation of an example system that includes a host machine within which a set of instructions to perform any one or more of the methodologies discussed herein may be executed.

### DESCRIPTION

The following disclosure may provide exemplary systems, devices, and methods for conducting a security or financial transaction and related activities. Although reference may be made to such security processes and transactions in the examples provided below, aspects are not so limited. That is, the systems, methods, and apparatuses may be utilized for any suitable purpose.

Before discussing specific embodiments, aspects, or examples, some descriptions of terms used herein are provided below.

“Account credentials” or “credentials” (collectively referred to as “credentials”) may include any information that identifies an account and allows an issuer, payment processor, or other entity to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “credential,” “account credential,” “account number,” or “payment credential,” may refer to any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a username, an expiration date, a gift card number or code, and any other suitable information.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

“Authentication” is a process by which the credential of an endpoint (including but not limited to applications, people, devices, process, and systems) can be verified to ensure that the endpoint is who they are declared to be.

The terms “client”, “client device”, “mobile device”, and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. As used herein, the terms “client”, “client device” and “user device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud services.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Physical credit cards, bank cards, debit cards, loan cards, and other payment cards, whether they utilize an EMV chip or not, are prone to card fraud, for example card swap or chip swap fraud. One example of this type of fraud can occur when an issuer sends a card, with the number and other account details, such as a user's address and account details or credentials, including an account number for example. The posted letter or other mailing containing a physical payment card, may be sent from the issuer or agent of the issuer, in an envelope or other package to the account holder, and with the physical card contained in the package being inactive card. A nefarious agent may intercept the package and replace the card with another card, such as a fake card that looks identical, or close to the original. Alternatively, the nefarious agent may replace the EMV chip with another chip but retain the original card.

The envelope or package may then be resent to the legitimate card user or account holder. After receiving the package containing the tampered card, the user may activate the card, either via an issuer interface or application on a computer or client device, or by calling the number printed on the card to activate the card, as well as by other activation mechanisms. Because the user has access to a card with all the correct details, they proceed to activate the card with the issuer bank or other issuer agency by providing details known to them such as their birth date, password, answer to secret account questions, or social security number as examples, as well as card details such as the card number, expiry date, CVV code and the like, and are able to successfully activate the card. Once active, the user is unable to use the card, either because the card itself is a fake, or because the chip in the card in their possession is an inactive or dummy chip, with the original card or chip with the nefarious agent. However, the nefarious agent is able to use the real card and/or the real chip in their possession after being activated by the account holder.

The technologies presented herein prevent card swap or chip swap fraud, in addition to other forms of fraud that require the original card or components of the card. The technologies presented utilize systems and methods using a wireless technology on a user device, for example an NFC connection, to validate the card prior to allowing or initiating an activation process. This means that an activation process is dependent on the successful validation of the card. The physical card may only be activated, or an activation process may only be initiated by the account holder if the physical card is in fact in their possession and is validated as genuine by the systems and methods disclosed. In several aspects the presented technologies also authenticate the user in addition to validating the card.

While traditional methods of card activation authenticate a user or account holder, for example by a user providing certain information known only to them as an account holder, the systems and methods described herein authenticate both the account holder, as well as the validity of the physical card, and link the two together in validation systems and processes that ensure that the validated physical card is in actual possession of the authenticated user during validation processes.

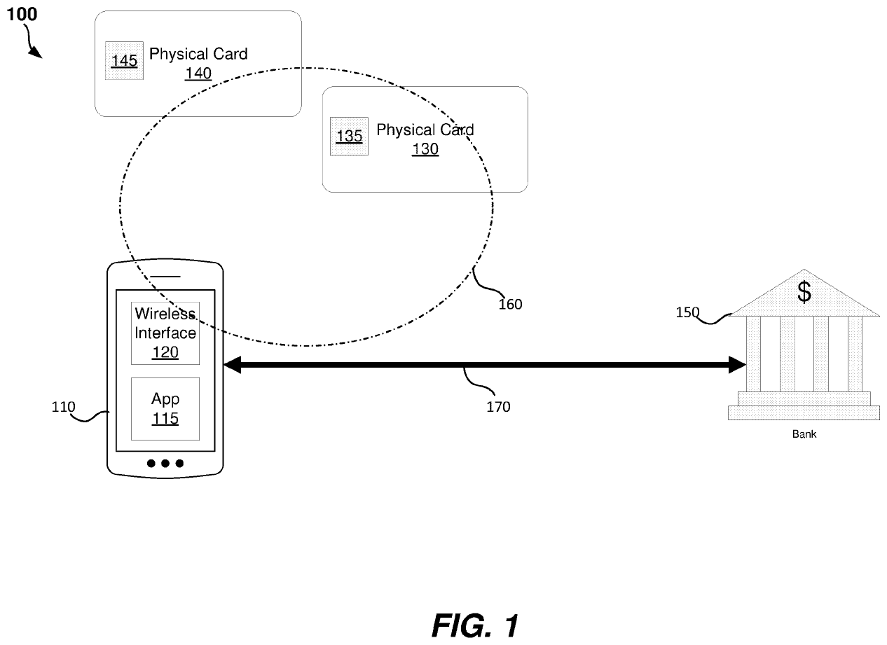

FIG. 1 illustrates a system architecture for securely validating a physical card for activation, according to at least one aspect of the present disclosure. System 100 may include a device such as a computing device, a client device, or user device 110 that for example may be a mobile or wearable device. Client device 110 may also include a wireless interface 120, that may comprise an NFC enabled chip, reader, transmitter, or other component to enable and facilitate NFC connections between client device 110 or any applications running on client device 110 and other NFC capable devices or chips, including for example a chip on a physical card 130. Physical cards 130, 140 may be equipped with an NFC-capable EMV chips 135, 145. The client device 110 may include an issuer interface, or App 115 (also referred to herein as “interface,” “issuer application,” or “application”), that may be or include native, hybrid, or web-based applications, or be a service hosted on a website and accessible on a browser for example.

App 115 and wireless interface 120 may communicate with each other, and other components in client device 110. App 115 may also connect or form a secure or encrypted communication or communication channel 170 with an issuer, issuer service, or issuer server 150. Wireless interface 120, in many embodiments has a limited, maximum, or predetermined range of communication 160 (also referred to herein as “communication distance”, or “communication range”). The range of communication 160 may depend on the type of communication that the wireless interface 120 is undertaking, or the type of communication device or component that wireless interface 120 is. For example, a Bluetooth transmitter or Bluetooth communication 160 can reach tens of feet, while a range of communication of NFC can typically have a range of communication 160 of a few inches.

In various aspects, a physical card or NFC capable device 140 may be within the range of communication 160 but is not detected because the components or interface capable of wireless communication, e.g. EMV chip 145, that is NFC-capable, or any other Bluetooth capable chip or component is not within the range of communication 160. Physical card 130 for example is detectable by the client device 110 because its EMV chip 135 is within the range of communication 160, and therefore is able to form a connection to the client device 110 via wireless interface 120, and communicate for example with App 115. In several aspects, the wireless interface 120 may poll nearby devices that are capable of wireless communications. This polling may be based on configurations or settings of the client device 110 or may be a direct result of App 115 being launched or being set to activate the wireless interface 120. The wireless interface 120 for example may be an NFC reader that polls nearby EMV capable physical cards 130, 140, once App 115 is launched and a user selects an option to discover nearby cards. Alternatively, the polling may occur automatically once the App 115 is launched. Alternatively, the polling may occur automatically and continuously independent from a specific application or other instructions.

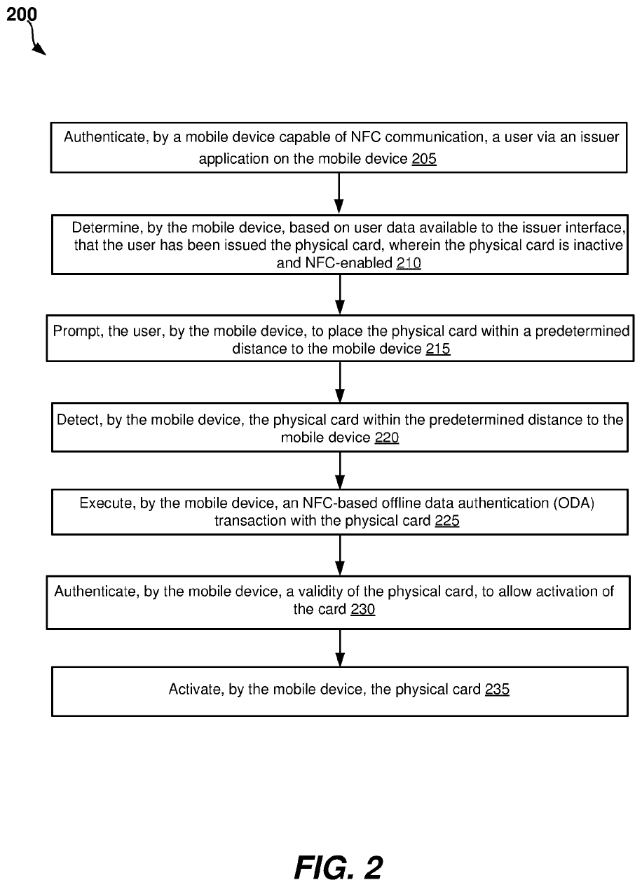

FIG. 2 is a flow diagram for one aspect of a method 200 to validate a physical card via NFC, according to at least one aspect of the present disclosure. Method 200 may commence with authenticating 205, via a mobile device (e.g., client device 110), a user via an issuer application, such as App 115, FIG. 1, on the mobile device. The authenticating 205 may be done via a password, a biometric signal or identification, or other suitable mechanisms to authenticate the user. As discussed above with greater detail, the application may in various aspects be a generic interface such as an issuer interface or service accessible via a browser, or alternatively be a web-based application, a hybrid application, or a native application. The authenticating 205 may be done on the mobile device via saved account credentials on the mobile device, or the authenticating 205 may be undertaken by contacting or communicating with an issuer or issuer service or server to confirm the user and/or account. In several embodiments, the mobile device determines 210 based on information available to it from the issuer or issuer service, and generally on the application, that the user has been issued a physical card, for example physical cards 130, 140, FIG. 1, and that the physical card is inactive and/or capable of wireless communication, for example NFC-enabled or capable of Bluetooth communication.

Once the mobile device determines 210 that the user has been issued a physical card, it may then prompt 215 the user, by the mobile device, to place the physical card within a predetermined distance, such as communication range 160, FIG. 1, to the mobile device. There may be an icon, a prompt or button that a user needs to press, select or interact with to indicate compliance with the prompt 215. If the physical card is placed within the predetermined distance, then the mobile device is able to detect 220 the physical card within the predetermined distance to the mobile device. Once the mobile device detects 220 the physical card it may execute 225 an NFC-based offline data authentication (“ODA”) transaction with the physical card 225. In various aspects, the ODA transaction is executed via the issuer application, wherein the issuer application directly connects with the physical card and undertakes the transaction. Upon success of the ODA transaction, then the mobile device may authenticate 230 the validity of the physical card, to allow activation of the card. In various aspects, the issuer application confirms the validity of the physical card, or authenticates 230 the physical card upon completion of a successful ODA transaction. Finally, in optional embodiments, the card may be activated 235 by the mobile device.

In various aspects, the App 115 may launch automatically upon detection by the mobile device, for example detection via a wireless interface 120, FIG. 1, of the physical card being within a communication range, for example communication range 160, FIG. 1, of the mobile device. In other aspects, if the App 115 is not installed on the device, the mobile device may automatically launch a download and/or installation process upon detection of the physical card within the communication distance or range. Alternatively, in some aspects, if the App 115 is not installed on the device, the mobile device may navigate the user to a download location of the App 115 upon detection of the physical card within the communication distance or range. In several aspects, the prompting 215 by the mobile device and/or App 115, only occurs based on location data attributable to the physical card, such as tracking data from the delivery or mail-delivery agency or organization, or GPS data, if the physical card, or its delivery mechanism, is capable of such communication, whereupon the prompting 215 feature is activated once the card is tracked to a specific location, for example an address belonging to the user or account holder.

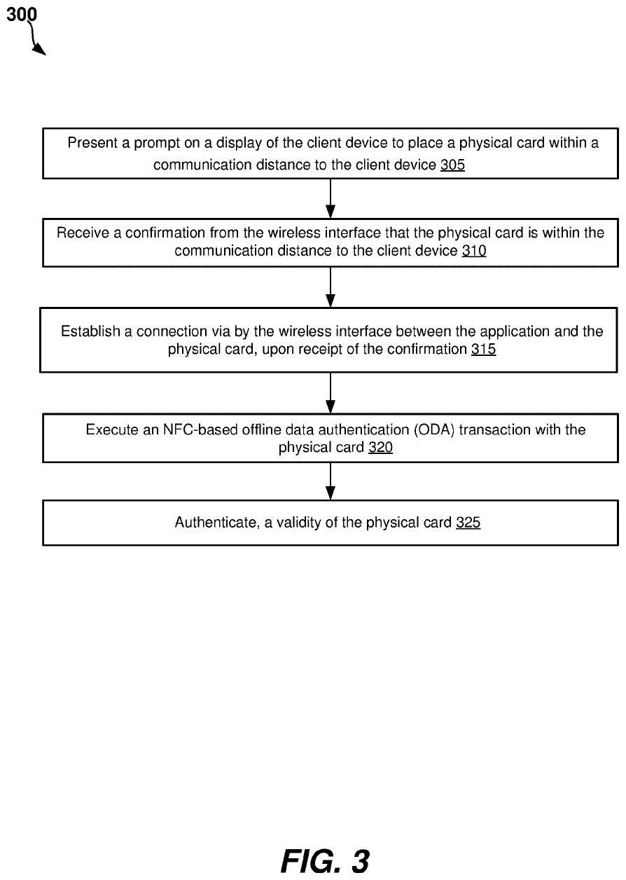

FIG. 3 is a flow diagram for one aspect of a method 300 to validate a physical card via an issuer application, e.g., App 115, FIG. 1, on a client or mobile device, e.g., client device 110, FIG. 1, and the interaction of various components of the client or mobile device, according to at least one aspect of the present disclosure. The method 300 may commence with an issuer application, e.g., App 115, FIG. 1, installed on a client device presenting 305 or displaying a prompt on a display of a client device, e.g., client device 110, FIG. 1, to place a physical card, for example physical cards 130, 140, FIG. 1, within a communication distance to the client device 110. This could for instance be triggered by the issuer application having access to data or information that a physical card has been issued to a user or account holder, based on a prompt from a user of the issuer application to activate a physical card, or based on tracking or location data of the physical card as discussed relating to the prompt 215, FIG. 2.

The method 300 may continue with the issuer application on the client device receiving 310 a confirmation from the wireless interface that the physical card 130 is within the communication distance 160 to the client device 110. Upon receipt of a confirmation that the physical card 130 is in communication range 160 to the client device 130, the issuer application establishes 315 a connection via a wireless interface between the issuer application and the physical card 130. Once the connection is established between the issuer application and the physical card 130, the issuer application commences to execute 320 an NFC-based ODA transaction with the physical card 130, and upon success of the ODA transaction, the issuer application authenticates 325 a validity of the physical card 130. Once the validity of the physical card 130 is authenticated 325 by the issuer application, a user may then activate the physical card 130 either via the issuer application, or via other mechanisms as discussed herein.

Optionally, the issuer application may also authenticate via pin numbers, passwords, or biometric mechanisms and likewise, a user prior to allowing the user to access features of the issuer application or prior to launching the issuer application with access to an issuer interface. Prior to the issuer application being launched, the mobile or client device 110, in several aspects, may receive data from the wireless interface for example an NFC enabled component, regarding detection of the physical card by the wireless interface. Once the client device 110 receives this information, it may then determine based on information available to the client device, or stored in the client device or accessible to it, by being for example in virtual or cloud storage, that the physical card 130 is associated with the issuer application, and if the issuer application is installed on the mobile device, it may then automatically launch the issuer application, or otherwise it may initiate a download and/or installation process of the application from an application store, or navigate the user to a download location of the application from an application store or likewise. In optional embodiments, the issuer application may also activate the physical card 130, or initiate an activation process upon the physical card being authenticated as valid.

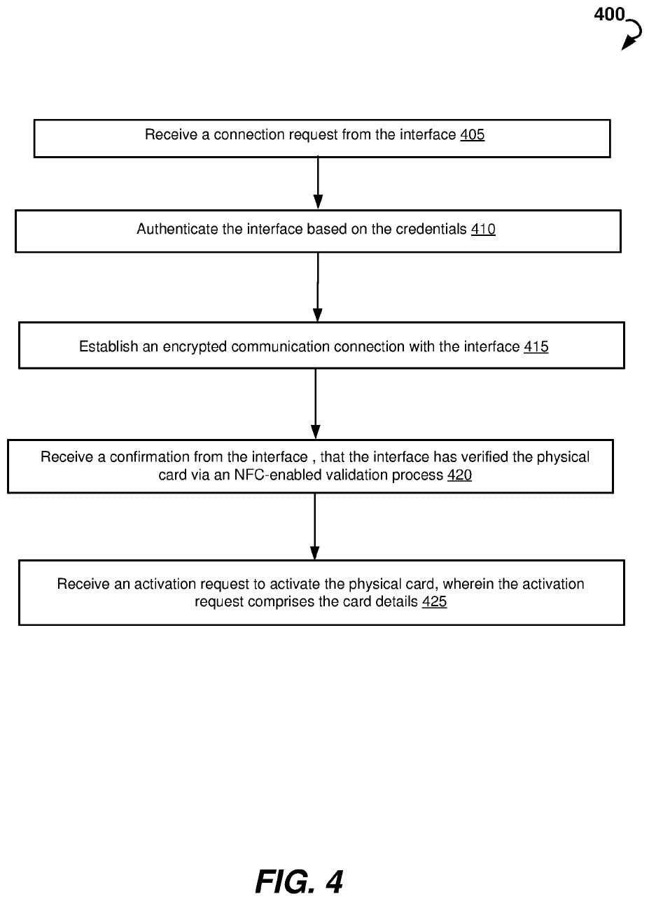

FIG. 4 is a flow diagram for one aspect of a method 400 to validate a physical card with an issuer server, or an issuer service that may be running on a server, according to at least one aspect of the present disclosure. Method 400 may in several aspects commence by an issuer service or server, for example issuer service or server 150, FIG. 1, receiving 405 a connection request, or receiving a request to establish a secure communication channel from an interface, such as an issuer application, for example App 115, FIG. 1, where the interface being one that may be provided by, or associated with the issuer, and installed on, or accessed by (for example, via a browser or web service) a remote client device, e.g., client device 110, FIG. 1. Based on the credentials of the account, user, or client device, the issuer service or server may authenticate 410 the interface, user and/or device to allow the request.

Once the issuer service or issuer server authenticates the credentials, it establishes 415 an encrypted and secure communication channel or connection with the issuer application or issuer interface running on the client device. Over this communication channel, the issuer service may receive 420 a confirmation from the interface, that the interface has verified the physical card via an NFC-enabled validation process, a process for example as described in FIGS. 2-3 and 5. The issuer service may also receive 425 an activation request to activate the physical card, wherein the activation request comprises card details of the physical card. The issuer service may initiate the request, authenticate the card based on the card details and activate the card. The issuer service may also communicate with the interface by issuing push or pull data requests and transmit notifications or popups that cause a notification or prompt to be displayed via the interface, on the client device accessing the interface.

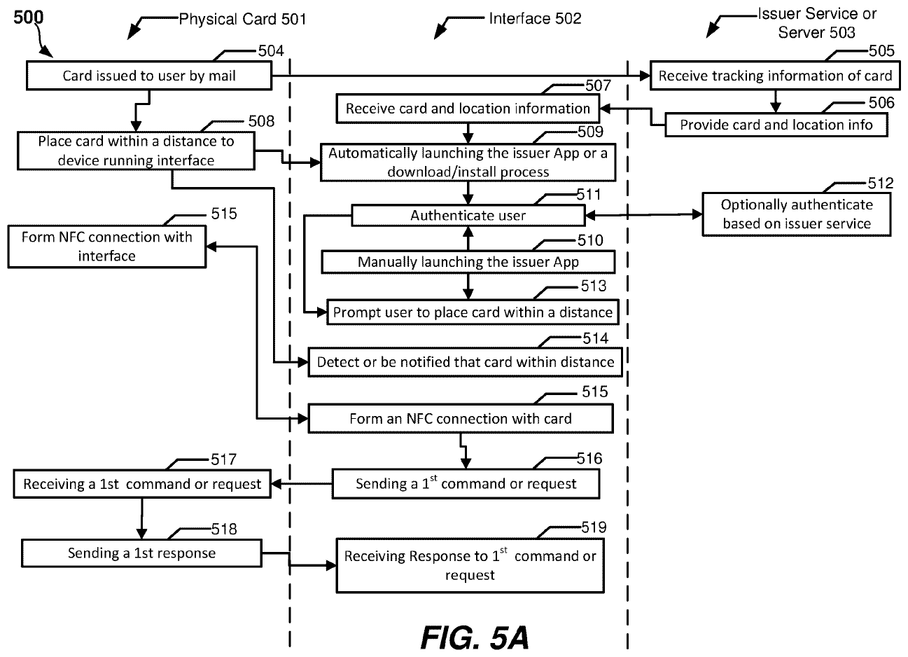

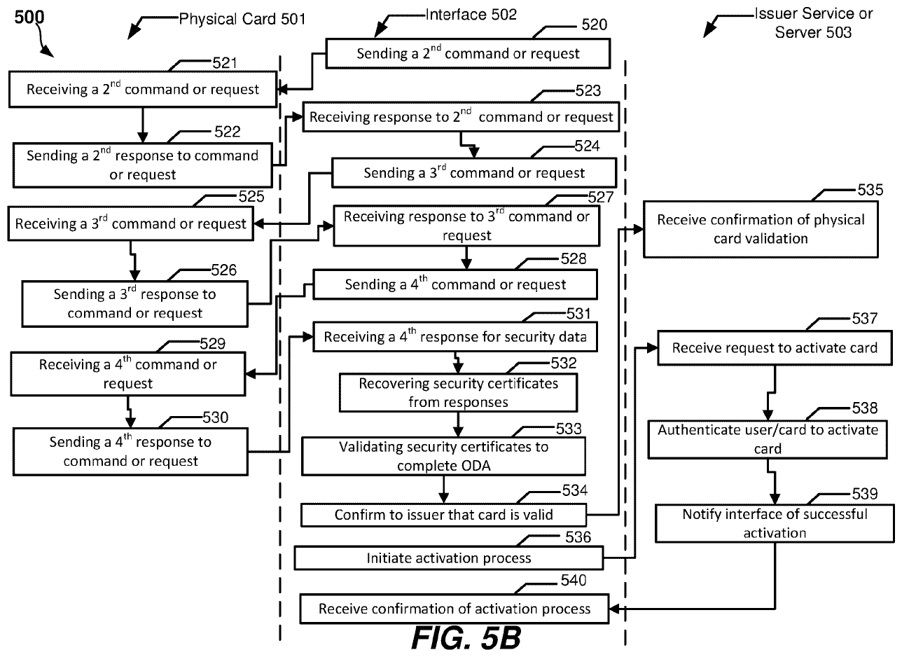

FIG. 5A-5B illustrates a diagrammatical representation of the various components of a system architecture for validating a physical card for activation, according to at least one aspect of the present disclosure. System 500 includes at least three distinct parts comprising a physical card or payment method 501, e.g., physical card 140, FIG. 1. The physical card 501 for example may contain an EMV or NFC-capable chip, such as NFC-capable EMV chip 145, FIG. 1, to connect to a wireless interface such as an NFC reader, e.g., wireless interface 120, FIG. 1, on a user device, computing device, wearable or other client device, e.g., client device 110, FIG. 1. These client devices may be running an issuer interface or interface 502, where the interface may include for example, App 115, FIG. 1. As described above, the App 115 may represent an application, website, web service, application, or even may include native mobile or computing device software or operating system conducting actions on a client device. In most aspects, the interface 502 is associated with the issuer, such as a banking application or website provided by an issuer. In several aspects some, a combination, or all the steps described as being undertaken by interface 502, may be undertaken by a wireless interface or NFC reader, such as wireless interface 120, FIG. 1, and/or by a client device, e.g., client device 110, FIG. 1. Finally, the system may also include an issuer service or server 503, e.g., issuer service 150, FIG. 1. This may be a server that runs a database, software, or a secure management portal of issuer programs and data.

System 500 may include a variety of tasks or processes, some of which are optional and may be combined in any suitable order. In one aspect of the system 500, a physical card 501, similar in many respects to the physical cards 130, 140, is issued 504 and sent or mailed to an account holder or user. Tracking information is received 505 by an issuer either from the postal or delivery company that is in charge of delivering the service or any other tracking service. Tracking information may also be received from the card 501 itself, a wireless interface on the card, such as wireless interface 120, FIG. 1, or an envelope, box, or other type of packaging the card is delivered with capable of wireless communication. The issuer or issuer service may provide 506 the card tracking information to interface 502, for example an issuer app on the mobile device. The interface 502 may receive 507 and/or store live or other information about the card, this information may include the location tracking data sent to it by the issuer service 503, as well as other information, for example a new card being issued, a new account being opened, a new user added to the account and the like.

In some aspects, a card that is received by a user may be placed 508 within a communication range, e.g., communication range 160, FIG. 1, to a device or a device running the interface 502. In several embodiment placing 508 a card within a communication range to a device running interface 502 may include tapping or touching the card 501 to the device. In several aspects, either a device running the interface 502 or interface 502 may receive data or information that the card is placed 508 within a communication range. In numerous examples, either the client device, for example via its operating system, or the interface 502, may automatically launch the issuer application upon receipt of data, for example from wireless interface 120, FIG. 1, or other part of the client device, that the physical card 501 is within a communication range or that it has been detected by the device. The client device may determine based on this and/or other information available to it, that the physical card is associated with the interface 502 or with the issuer service 503, or that it is relevant to a user of the client device, upon which the client device may automatically launch 509 the interface 502. If the interface 502 is not installed on the device, the device may launch a download and/or installation process for the interface 502, including for example, by accessing an application store and downloading the interface or app 502 from the application store, wherein the downloading may be automatic or manual.

In several other aspects the interface 502 may be launched manually 510 by a user, for example by opening an application or going to a website on a browser and logging in. The interface 502 may authenticate 511 the device and/or the user logging into the device with account credentials stored or associated with the device running interface 502 or provided by the user. In optional embodiments, the authenticating 511 may also involve transmitting data to, or authenticating 512 the credentials or the login attempt with issuer service 503 and/or receiving permission, confirmation, or authentication from the issuer service or server 503. Once the issuer interface is launched and a user is authenticated 511, the user may be prompted 513 to place the physical card 501 within a communication range to the device running interface 502. If the card 501 is placed 508 within the communication range to the client device, then either the client device via the wireless interface, such as an NFC-reader or otherwise, or the interface 502, for example the App, receive information to allow it to detect 514 and/or determine via received data that the card is within the communication range to the client device. The wireless interface itself may detect the physical card 501 and provide confirmation that a card has been detected or successfully paired with to interface 502 or to the client device. In several embodiments, the wireless interface or NFC-capable component has a polling mechanism, where the wireless interface attempts to continuously poll nearby cards, and when the card is identified it attempts a handshake procedure to form a secure NFC connection between the wireless interface and the physical card 501.

An NFC connection may be formed 515 between the device and/or the interface 502 and the physical card 501 (or with the NFC-capable EMV chip on physical card 501), for example via a wireless interface on the client device. In several aspects, the interface 502 may, via the established NFC connection, communicate with the physical card 501 directly, to conduct an ODA transaction, which may begin by sending 516 a first command or request for information about the card which is received 517 by physical card 501. The command may be or include a Proximity Payment System Environment (“PPSE”) command. The physical card 501 may send 518 a PPSE response that is received 519 by interface 502, where the response provides an application identifier (“AID”) information that confirms that it is a card belonging to a specific issuer or payment network. For example, a VISA AID would confirm that the card is a VISA card and may include a product identifier to identify the type of card product the physical card 501 is, for example a credit card, or debit card, and whether the card includes certain features such as a pin or VISA Wavepay as examples.

The interface 502 may then send 520 a second command or request that is received 521 by the physical card 501. The second command may include or be a SELECT AID request, such as a SELECT VISA AID request that attempts to access information stored on the chip via the AID identifier provided by the physical card at step 518 and determine whether the card 501 and/or files or data in the chip or card 501 are in a ready state. The physical card 501 may respond by sending 522 a second response or response to the second command, where the response sent 522 may comprise a SELECT response which communicates to the interface 502 that the card 501 (or EMV chip) is ready or available for further steps.

Upon receiving 523 the response to the second command, the interface 502 may then send 524 a third command that is received 525 by the physical card 501. This third command may request security data from the EMV chip to validate the card 501. The third command or request that is sent 524 may be a GET PROCESSING OPTIONS (“GPO”) command that asks for one or more encryption keys or certificates. The card 501 may send 526 a third response which may include a GPO response. The response received 527 by interface 502 may contain an application file locator (also referred to as “AFL”). If the response received 527 does contain an AFL then, the interface 502 may send 528 another request to physical card 501, as a fourth command or request 528, this command sent 528 may be a READ RECORD command(s) for example. The card may receive 529 this command and send 530 a response to the interface 502 that is a READ RECORD response. Steps 528 to 531 are only necessary if an AFL is contained in one or the responses, and/or if the file sizes for the security data requested by the third command is too large to be contained in one response, i.e., too large to only be contained in response 526.

The response sent in steps 526 and 530 may contain security data that were requested in steps 524 and 528 respectively. These responses may contain security certificates which in turn may contain the public key of the issuer or issuer service 503 as well as other public keys. The interface 502 may attempt to recover 532 these certificates and keys, and upon successful recovery from the certificates received is able to validate 533 that the physical card 501 (and/or the EMV chip on the card 501) is an authentic card and/or with an authentic EMV chip. Upon successful validation 533 the interface 502 may send 534 a confirmation, transmission, or message to the issuer or issuer service 503 that the card received by a user and validated by interface 502 (and/or by the wireless interface/NFC reader, and/or device running interface 502) is authentic and confirm it is in possession of the user. The combination of the user being authenticated when logging in or launching the interface for example at step 511, as well as the validation 533 of the card 501, provides a multi-factor authentication as well as authentication of not only a user but also of a card and links the possession/location of the card with the account holder/user. In traditional methods of activating a card, the user may be authenticated but the physical card is not. The confirmation of the validity of physical card 501 may be received 535 by issuer service or issuer server 503.

Optionally, an activation process of physical card 501 may be initiated 536 by the interface 502 by sending a request to activate the card 501 to issuer service or server 503 which may proceed to authenticate 538 the card based on the data it receives 537. Upon authentication 538 of card 501, the issuer service 503 may then notify 539 the interface 502 of successful activation of the card, this notification is received 540 by interface 502 and may be displayed to a user on the client device running interface 502, for example as a pop-up or push notification telling them that the physical card 501 is now activated and may be used.

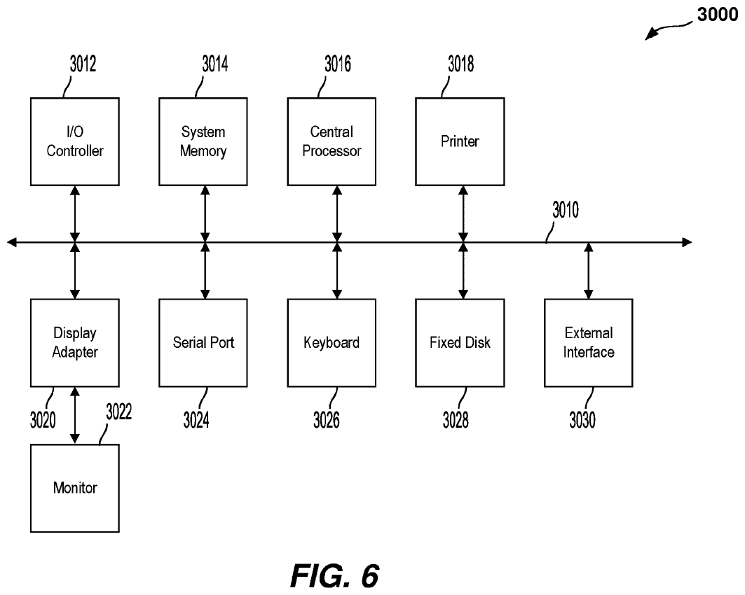

FIG. 6 is a block diagram of a computer apparatus 3000 with data processing subsystems or components, which a set of instructions to perform any one or more of the methodologies discussed herein may be executed, according to at least one aspect of the present disclosure. The subsystems shown in FIG. A are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

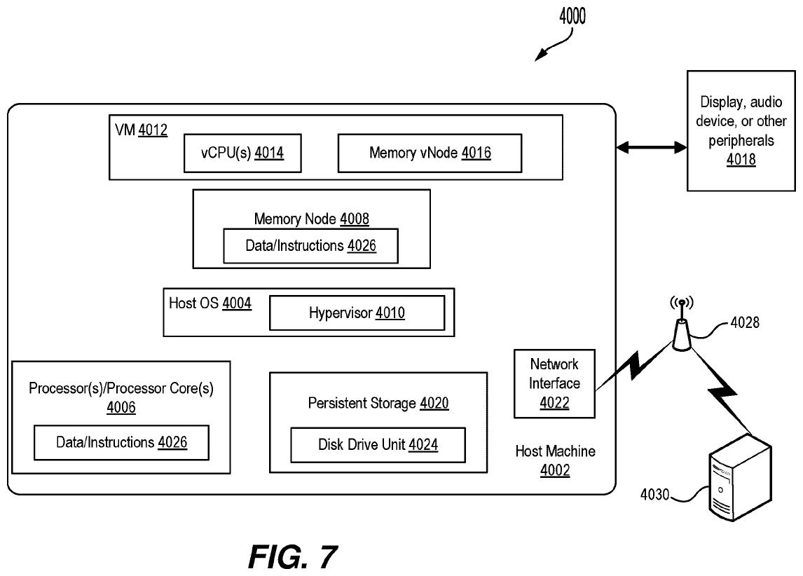

FIG. 7 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A computer implemented method for securely activating a physical card capable of near field communication (NFC), the card provided by an issuer to a user, wherein the method comprises authenticating, by a mobile device capable of NFC communication, the user via an issuer application on the mobile device; determining, by the mobile device, based on user data available to the issuer application, that the user has been issued the physical card, wherein the physical card is inactive and NFC-enabled; prompting, the user, by the mobile device, to place the physical card within a communication distance to the mobile device; detecting, by the mobile device, the physical card within the communication distance to the mobile device; executing, by the mobile device, an NFC-based offline data authentication (ODA) transaction with the physical card; based on a success of the NFC-based ODA transaction, authenticating, by the mobile device, a validity of the physical card with the issuer, to allow activation of the card; and activating, by the card issuer, the physical card.

Clause 2. The method of Clause 1, further comprising automatically launching the issuer application upon placement of the physical card within the communication distance to the mobile device.

Clause 3. The method of any of Clauses 1-2, further comprising at least one of automatically triggering a download of the issuer application into the mobile device upon placement of the physical card within the communication distance to the mobile device, or automatically navigating to a download location of the issue application upon placement of the physical card within the communication distance to the mobile device.

Clause 4. The method of any of Clauses 1-3, wherein the prompting is based on a location data available to the mobile device, the location data comprised of at least one of physical card location data, or user location data.

Clause 5. The method of any one of Clauses 1-4, wherein the detecting of the physical card within the communication distance comprises detecting the physical card being tapped to the mobile device.

Clause 6. The method of any one of Clauses 1-5, wherein the mobile device utilizes an NFC polling mechanism configured to automatically detect and attempt to connect to nearby NFC-enabled cards.

Clause 7. The method of any one of Clauses 1-6, further comprising establishing, a connection, via the NFC, between the mobile device and the physical card link.

Clause 8. The method of any one of Clauses 1-7, further comprising establishing, a connection, via the NFC, between the issuer application and the physical card, upon the issuer application determining that the physical card is within the communication distance from the mobile device.

Clause 9. The method of any one of Clauses 1-8, wherein the authenticating of the user is based on at least one of a PIN code, a password, or a user biometric.

Clause 10. The method of any one of Clauses 1-9, wherein the NFC based ODA transaction comprises sending by the issuer application, via the NFC, a first command to the physical card to obtain card information from the physical card; receiving by the issuer application, via the NFC, the card information from the physical card in response to the first command; sending by the issuer application, via the NFC, a second command to the physical card, based on the card information, to obtain security data; and receiving by the issuer application, via the NFC, a response that comprises at least one of the security data, or an application file locator.

Clause 11. The method of any one of Clauses 1-10, wherein the ODA transaction further comprises based on receiving the application file locator, sending by the issuer application, via the NFC, a third command to the physical card to obtain additional security data based on the application file locator; and receiving by the issuer application, via the NFC, the additional security data.

Clause 12. The method of any one of Clauses 1-11, wherein the NFC-based ODA transaction further comprises recovering, by the issuer application, security certificates from the security data; and validating, by the issuer application, the security certificates to successfully complete the NFC-based ODA transaction.

Clause 13. The method of any one of Clauses 1-12, wherein the security data comprises at least one of an encryption key, or a security certificate.

Clause 14. A client device comprising a display; a wireless interface capable of Near-Field Communication (NFC); a processor in communication with the wireless interface; and a memory in communication with the processor, the memory comprising an application associated with an issuer, wherein the application comprises instructions to be executed by the processor to present a prompt on the display of the client device to place a physical card within a communication distance to the client device; receive a confirmation from the wireless interface that the physical card is within the communication distance to the client device; establish a connection by the wireless interface between the application and the physical card within the communication distance; execute an NFC-based offline data authentication (ODA) transaction with the physical card; and based on a success of the NFC-based ODA transaction, authenticate, a validity of the physical card.

Clause 15. The client device of Clause 14, wherein the processor is configured to receive data regarding detection of the physical card by the wireless interface; determine, based on information available to the client device, that the physical card is associated with the application; and launch the application automatically upon the determining that the physical card is associated with the issuer.

Clause 16. The client device of any one of Clauses 14-15, wherein the application further comprises instructions to authenticate a user with the issuer to allow access to the application.

Clause 17. The client device of any one of Clauses 14-16, wherein the application further comprises instructions to establish a connection between the application and a remote issuer system; and receive data from the remote issuer system indicating that the physical card has been issued to the user.

Clause 18. The client device of any one of Clauses 14-17, wherein the application further comprises instructions to transmit a data object comprising a confirmation of the validity of the physical card to the remote issuer system; and initiate a card activation process with the remote issuer system to enable use of the physical card.

Clause 19. An issuer system to authenticate a physical card in communication with a remote client device, the issuer system comprising an issuer interface; and a server running an issuer service, the issuer service configured to: receive a connection request from the issuer interface to establish a secure communication channel between the issuer interface and the issuer service, wherein the connection request comprises credentials provided by the issuer interface; authenticate the issuer interface based on the credentials; establish an encrypted communication channel with the issuer interface; receive a confirmation, from the issuer interface, indicative of a successful verification of the physical card via an NFC-enabled validation process; and receive an activation request to activate the physical card, wherein the activation request comprises card details.

Clause 20. The issuer system of Clause 19 wherein the issuer service is further configured to authenticate the physical card based on the card details and data available to the issuer service; activate the card on behalf of the issuer; and transmit a notification to the interface confirming a successful activation of the physical card.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A computer implemented method for securely activating a physical card capable of near field communication (NFC), the card provided by an issuer to a user, wherein the method comprises:
authenticating, by a mobile device capable of NFC communication, the user via an issuer application on the mobile device;
determining, by the mobile device, based on user data available to the issuer application, that the user has been issued the physical card, wherein the physical card is inactive and NFC-enabled;
prompting, the user, by the mobile device, to place the physical card within a communication distance to the mobile device;
detecting, by the mobile device, the physical card within the communication distance to the mobile device;
executing, by the mobile device, an NFC-based offline data authentication (ODA) transaction with the physical card;
based on a success of the NFC-based ODA transaction, authenticating, by the mobile device, a validity of the physical card with the issuer, to allow activation of the card; and
activating, by the card issuer, the physical card.

2. The method of claim 1, further comprising:
automatically launching the issuer application upon placement of the physical card within the communication distance to the mobile device.

3. The method of claim 1, further comprising at least one of:
automatically triggering a download of the issuer application into the mobile device upon placement of the physical card within the communication distance to the mobile device, or
automatically navigating to a download location of the issue application upon placement of the physical card within the communication distance to the mobile device.

4. The method of claim 1, wherein the prompting is based on a location data available to the mobile device, the location data comprised of at least one of physical card location data, or user location data.

5. The method of claim 1, wherein the detecting of the physical card within the communication distance comprises detecting the physical card being tapped to the mobile device.

6. The method of claim 1, wherein the mobile device utilizes an NFC polling mechanism configured to automatically detect and attempt to connect to nearby NFC-enabled cards.

7. The method of claim 1, further comprising:
establishing, a connection, via the NFC, between the mobile device and the physical card link.

8. The method of claim 1, further comprising:
establishing, a connection, via the NFC, between the issuer application and the physical card, upon the issuer application determining that the physical card is within the communication distance from the mobile device.

9. The method of claim 1, wherein the authenticating of the user is based on at least one of a PIN code, a password, or a user biometric.

10. The method of claim 1, wherein the NFC based ODA transaction comprises:
sending by the issuer application, via the NFC, a first command to the physical card to obtain card information from the physical card;
receiving by the issuer application, via the NFC, the card information from the physical card in response to the first command;
sending by the issuer application, via the NFC, a second command to the physical card, based on the card information, to obtain security data; and
receiving by the issuer application, via the NFC, a response that comprises at least one of the security data, or an application file locator.

11. The method of claim 10, wherein the ODA transaction further comprises:
based on receiving the application file locator, sending by the issuer application, via the NFC, a third command to the physical card to obtain additional security data based on the application file locator; and
receiving by the issuer application, via the NFC, the additional security data.

12. The method of claim 10, wherein the NFC-based ODA transaction further comprises:
recovering, by the issuer application, security certificates from the security data; and
validating, by the issuer application, the security certificates to successfully complete the NFC-based ODA transaction.

13. The method of claim 10, wherein the security data comprises at least one of an encryption key, or a security certificate.

14. A client device comprising:
a display;
a wireless interface capable of Near-Field Communication (NFC);
a processor in communication with the wireless interface; and
a memory in communication with the processor, the memory comprising an application associated with an issuer, wherein the application comprises instructions to be executed by the processor to:
present a prompt on the display of the client device to place a physical card within a communication distance to the client device;
receive a confirmation from the wireless interface that the physical card is within the communication distance to the client device;
establish a connection by the wireless interface between the application and the physical card within the communication distance;
execute an NFC-based offline data authentication (ODA) transaction with the physical card; and
based on a success of the NFC-based ODA transaction, authenticate, a validity of the physical card.

15. The client device of claim 14, wherein the processor is configured to:
receive data regarding detection of the physical card by the wireless interface;
determine, based on information available to the client device, that the physical card is associated with the application; and
launch the application automatically upon the determining that the physical card is associated with the issuer.

16. The client device of claim 14, wherein the application further comprises instructions to:
authenticate a user with the issuer to allow access to the application.

17. The client device of claim 14, wherein the application further comprises instructions to:
establish a connection between the application and a remote issuer system; and
receive data from the remote issuer system indicating that the physical card has been issued to the user.

18. The client device of claim 14, wherein the application further comprises instructions to:
transmit a data object comprising a confirmation of the validity of the physical card to the remote issuer system; and
initiate a card activation process with the remote issuer system to enable use of the physical card.

19. An issuer system to authenticate a physical card in communication with a remote client device, the issuer system comprising:
an issuer interface; and
a server running an issuer service, the issuer service configured to:
receive a connection request from the issuer interface to establish a secure communication channel between the issuer interface and the issuer service, wherein the connection request comprises credentials provided by the issuer interface;
authenticate the issuer interface based on the credentials;
establish an encrypted communication channel with the issuer interface;
receive a confirmation, from the issuer interface, indicative of a successful verification of the physical card via an NFC-enabled validation process; and
receive an activation request to activate the physical card, wherein the activation request comprises card details.

20. The issuer system of claim 19 wherein the issuer service is further configured to:
authenticate the physical card based on the card details and data available to the issuer service;
activate the card on behalf of the issuer; and
transmit a notification to the interface confirming a successful activation of the physical card.
